(19) United States
(12) Patent Application Publication
(10) Pub. No.: US 2026/0330623 A1
(43) Pub. Date: Oct. 22, 2026

(54) DYNAMIC VISIBLE IMAGE ANNOTATIONS AND TAGGING IN INDUSTRIAL TEST, MEASUREMENT, AND INSPECTION TOOLS

(71) Applicant: Fluke Corporation, Everett, WA (US)

(72) Inventor: Michael D. Stuart, Issaquah, WA (US)

(21) Appl. No.: 19/180,889

(22) Filed: Apr. 16, 2025

(51) Int. Cl. G06T 7/00; G06T 1/60; G06V 20/70

(52) U.S. Cl. CPC G06T 7/0008; G06T 1/60; G06V 20/70; G06T 2207/30164

(57) ABSTRACT

Methods, devices, and systems for associating previously-captured visible image annotations with primary inspection data. During a first time prior to an object being inspected, an inspection device may obtain or capture a visible image annotation related to the object to be inspected. In some embodiments. The inspection device stores the visible image annotation locally on the inspection device. During inspection of the object at a second time after the first time, the inspection device captures the primary inspection data of the object, which can also be stored locally on the inspection device. The inspection device associates the primary inspection data that was captured during the inspection with the visible image annotation that was captured prior to the inspection. The association between the primary inspection data and the visible image annotation can then be stored on the inspection device.

### BACKGROUND

### Technical Field

The present disclosure relates to industrial testing tools, and more particularly to dynamically annotating and tagging visible images captured relative to use of the industrial testing tools.

### Description of the Related Art

Commercial and industrial installations, applications, and systems may undergo various inspections or tests. For example, periodic inspections may be required or used to ensure optimum reliability and operation of industrial and commercial equipment and systems. These inspections may use different types of inspection tools to measure or record various operational parameters, e.g., electrical voltage, electrical current, electrical resistance, electrical power, vibration, motion, heat, sound, ultrasound, etc. For example, thermal imaging cameras have long been used in many settings to measure temperature profiles and analyze thermal variations and differences of objects. Such thermal images can be used to immediately identify faults or failures, or they can be compared to previous thermal images to identify issues that develop over time. But storing, maintaining, and tracking inspection data can be difficult, especially when other information (e.g., a serial number of the object being inspected, the location of the object in a building, a visual appearance of the object, etc.) is to be associated with the inspection data. It is with respect to these and other considerations that the embodiments herein have been made.

### BRIEF SUMMARY

Briefly, embodiments are directed to methods, devices, and systems for associating previously-captured visible image annotations with primary inspection data. In general, embodiments are directed to utilization of a visible-light camera on an inspection device to capture visible-light image annotations prior to the initiation of an inspection of an object. After the visible-light image annotations are captured by and stored on the inspection device, the inspection of the object can be initiated. During inspection of the object, the inspection device utilizes one or more inspection sensors to capture the primary inspection data of the object. In some embodiments, the inspection device automatically associates the primary inspection data that was captured during the inspection with the visible image annotation that was captured prior to the inspection. In other embodiments, the user may select one or more visible image annotations that were captured prior to the inspection for the inspection device to associate with the primary inspection data. In this way, the user can capture visible image annotations prior to an inspection, which improves the efficiency and effectiveness of the inspection.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings:

FIG. 1 illustrates a block diagram showing one embodiment of an inspection device system for dynamically capturing and annotating visible images relative to use of an inspection sensor in accordance with embodiments described herein.

FIGS. 2A-2B illustrate a logical flow diagram showing one embodiment of a process for dynamically capturing and annotating visible images relative to use of an inspection sensor in accordance with embodiments described herein.

FIG. 3 shows a system diagram that describe various implementations of computing systems for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, actions, or characteristics of the present disclosure, and are not limited to the same or different embodiments unless the context clearly dictates otherwise. Furthermore, the described features, structures, functions, limitations, actions, or characteristics may be combined in any suitable manner in accordance with this disclosure, and references to “in one embodiment,” “in another embodiment,” “in various embodiments,” “in some embodiments,” “in other embodiments,” etc., do not preclude the combination of the features, structures, functions, limitations, actions, or characteristics in any of the embodiments described herein. Accordingly, embodiments described herein can be combined in any combination unless the context clearly dictates otherwise.

For the purposes of the present disclosure, unless otherwise indicated, the phrase “A and B” is nonlimiting and means one or more of (A) and one or more of (B); the phrase “A or B” is nonexclusive and means one or more of (A), one or more of (B), or one or more of (A and B); the phrase “A and/or B” means one or more of (A), one or more of (B), or one or more of (A and B); the phrase “at least one of A and B” and the phrase “one or more of A and B” both mean one or more of (A) and one or more of (B); and the phrase “at least one of A or B” and the phrase “one or more of A or B” both mean one or more of (A), one or more of (B), or one or more of (A and B). By way of extension, for example, the phrases “at least one of A, B, or C” and “one or more of A, B, or C” both mean one or more of (A), one or more of (B), one or more of (C), one or more of (A and B), one or more of (A and C), one or more of (B and C), or one or more of (A, B and C). In the above, A, B, and C represent any form or type of element, feature, arrangement, component, structure, aspect, action, step, etc. references.

In various types of commercial and industrial installations, applications, and systems, one or more inspections or tests may be performed. For example, periodic inspections are required or used to ensure optimum reliability and operation of industrial and commercial equipment and systems. Inspections may measure or record various operational parameters, e.g., electrical voltage, electrical current, electrical resistance, electrical power, vibration, motion, heat, sound, ultrasound, etc. To perform these inspections, one or more inspection tools may be utilized. Examples of such inspection tools may include infrared-sensitive cameras (e.g., thermal imagers, infrared imagers), acoustic imaging cameras (e.g., sound imagers, ultrasound imagers), a multimeter, and other types of testing, measuring, or inspection tools or devices. Some of these tools include features that allow a user to capture or record inspection or primary data (which may be stored as an inspection data file or a primary data file) and then capture a visible light image or video that can be used as a contextual annotation to the inspection data. These visible images and videos offer valuable context and information about the location and environment in which the inspection occurred, along with potentially valuable secondary information that allows more robust analysis to detect issues. Furthermore, the visible images and videos can provide information that enables the specific identification of the equipment under inspection (e.g., nameplates, alpha-numeric labels, serial numbers, identifying marks, identifying shapes and components, etc.). But current tools generally require the inspection or primary data to be captured first, followed by the visible light images. One example of such an inspection and annotation tool is described in U.S. Pat. No. 9,176,990. But embodiments described herein provide additional benefits and improvements on such tools.

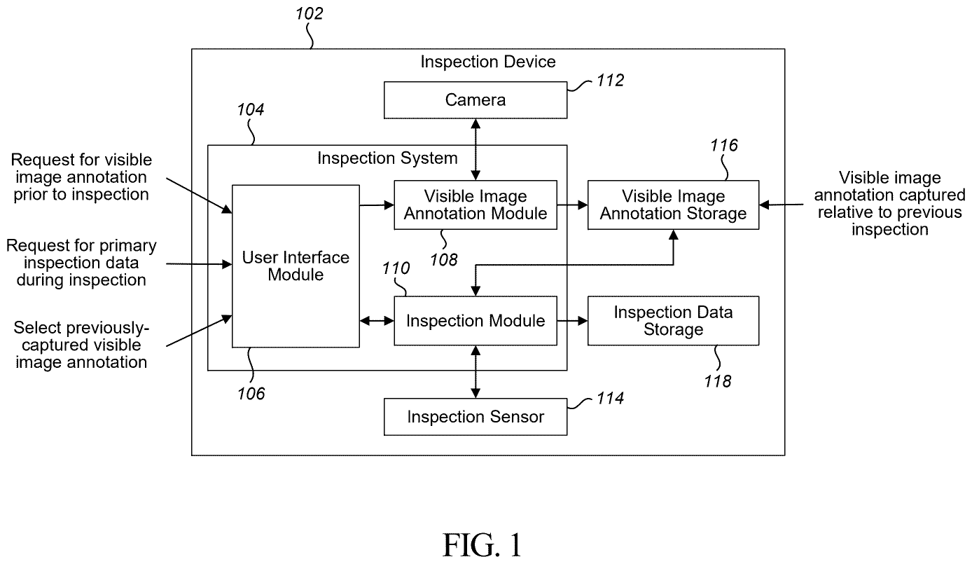

FIG. 1 illustrates a block diagram showing one embodiment of an inspection device or system 102 for dynamically capturing and annotating visible images relative to use of an inspection sensor in accordance with embodiments described herein.

The inspection device 102 includes an inspection system 104, a camera 112, an inspection sensor 114, visible image annotation storage 116, and inspection data storage 118.

The camera 112 is a visible-light camera and is configured to capture one or more visible-light images or visible-light video, which are also referred to herein as visible images or visible video. As described herein, the user of the inspection device is enabled to capture one or more visible images or visible videos via the camera 112 prior to an inspection of an object. These visible images or visible videos can then be used to annotate later-captured inspection data. As such, the visible images or visible videos are stored as visible image annotations in the visible image annotation storage 116.

The visible image annotation storage 116 is configured to store one or more visible image annotations. In some embodiments, the visible image annotation storage 116 stores visible image annotations that are captured by the camera 112 prior to an inspection, such as at a time leading up to the inspection or during a separate, prior inspection performed by the inspection device 102. In other embodiments, the visible image annotation storage 116 stores one or more visible image annotations that were captured by another computing device or system, which were received by the inspection device 102 from another computing device or system prior to an inspection. In some embodiments, the other computing device or system may be another inspection device 102 that performed an inspection. In other embodiments, the other computing device or system may be a smart phone or other type of device that captured a visible image annotation or other type of annotation (e.g., sound recordings). One example system for receiving such visible image annotations from a separate device is described in U.S. Pat. No. 10,337,962,

The visible image annotation storage 116 may include short-term, long-term storage, or a combination thereof. In some embodiments, the visible image annotation storage 116 may include a temporary cache, or short-term storage, that is configured to store visible image annotations for a limited time or a limited purpose. In other embodiments, the visible image annotation storage 116 may include a permanent cache, or long-term storage, that is configured to store visible image annotations until deleted.

The inspection sensor 114 includes one or more sensors that are configured to capture inspection data of an object during an inspection, which may also be referred to as primary data or primary inspection data. The inspection sensor 114 may include, but is not limited to, infrared-sensitive cameras (e.g., thermal imagers, infrared imagers), acoustic imaging cameras (e.g., sound imagers, ultrasound imagers), multimeter sensors, or other inspection sensors or devices. Accordingly, in some embodiments, the inspection sensor 114 may include at least one infrared sensor configured to capture infrared data of an object during an inspection of the object. In other embodiments, the inspection sensor 114 may include at least one acoustic sensor configured to capture acoustic data of an object during an inspection of the object. In yet other embodiments, the inspection sensor 114 may include at least one electromagnetic field sensor configured to capture electromagnetic data of the object during an inspection of the object. In some other embodiments, the inspection sensor 114 may include at least one vibration sensor configured to capture vibration data of the object during an inspection of the object. Once captured, the inspection data is stored in inspection data storage 118.

The inspection data storage 118 is configured to store inspection data that is captured by the inspection sensor 114. In some embodiments, the inspection data storage 118 stores primary inspection data prior to being annotated. In other embodiments, the inspection data storage 118 stores primary inspection data that has been associated with one or more visible image annotations that were previously captured and stored in the visible image annotation storage 116.

The inspection system 104 is configured to capture visible image annotations via the camera 112 and then associate them with inspection data later captured via the inspection sensor 114. The inspection system 104 may include a user interface module 106, a visible image annotation module 108, and an inspection module 110. Although the user interface module 106, the visible image annotation module 108, and the inspection module 110 are illustrated as separate modules, embodiments are not so limited. Rather, one module or a plurality of modules may perform the functionality of the user interface module 106, the visible image annotation module 108, and the inspection module 110.

The visible image annotation module 108 is configured to the utilize the camera 112 to capture visible image annotations in response to the user interface module 106 receiving a user request to capture visible image annotations. The visible image annotation module 108 is also configured to store the captured visible image annotations in the visible image annotation storage 116.

The inspection module 110 is configured to initiate the inspection of an object in response to the user interface module 106 receiving a user request to initiate an inspection to capture inspection data. During the inspection, inspection module 110 utilizes the inspection sensor 114 to capture primary inspection data. Once the primary inspection data is captured, the inspection module 110 accesses the visible image annotation storage 116 to associate previously-captured visible image annotations with the captured primary inspection data. In some embodiments, the inspection module 110 works with the user interface module 106 to enable the user to select one or more of the previously-captured visible image annotations to associate with the captured primary inspection data. In other embodiments, the inspection module 110 automatically selects one or more of the previously-captured visible image annotations to associate with the captured primary inspection data. The inspection module 110 can then store the captured primary inspection data and the association with the previously-captured visual image annotations in inspection data storage 118.

The user interface module 106 is configured to output or display information to a user of the inspection device 102 and to receive input from the user. The user interface module 106 can receive a request from a user to capture visible image annotations prior to an inspection. The user interface module 106 coordinates the capturing of the visible image annotation with the visible image annotation module 108. After visible image annotations are captured or obtained, the user interface module 106 can receive a request from the user to capture primary inspection data. The user interface module 106 coordinates the capturing of the primary inspection data with the inspection module 110. In some embodiments, the user interface module 106 displays previously-captured visible image annotations to the user and receives a user selection of one or more previously-captured visible image annotations to be associated with the captured primary inspection data.

As an illustrative example, an electrician may need to inspect an electrical distribution panel with an infrared camera and identify the various components within the panel. The infrared camera requires direct line-of-sight to the components under inspection and cannot sufficiently provide actionable data through solid panel doors. The identifying labels of the components within the panel, however, may be on the outside of the panel door. The inspection device 102 described herein enables the electrician to first capture relevant visible light image annotations of the identifying labels via camera 112, which are stored in the visible image annotation storage 116. After this is done, the electrician can open the panel door and initiate the inspection of the electrical distribution panel with the infrared camera being inspection sensor 114. The inspection system 102 of the inspection device 102 can then automatically append the previously-captured annotation images to the captured thermal inspection images, or the electrician can select which of the previously-captured annotation images to append to the captured thermal inspection images.

As another illustrative example, a mechanical technician may inspect rolling element bearings on a long machine that has numerous inspection points. The technician can utilize the camera 112 on the inspection device 102 to capture relevant visible annotation images. As the technician utilizes the inspection sensor 114 on the inspection device 102 to capture acoustic image data for each inspection point on the machine, the inspection system 102 of the inspection device 102 can associate the previously-captured relevant visible annotation images with the captured acoustic image data captured at each inspection point. In this way, the technician does not have to interrupt their inspection after each inspection point to capture the relevant visible annotation images.

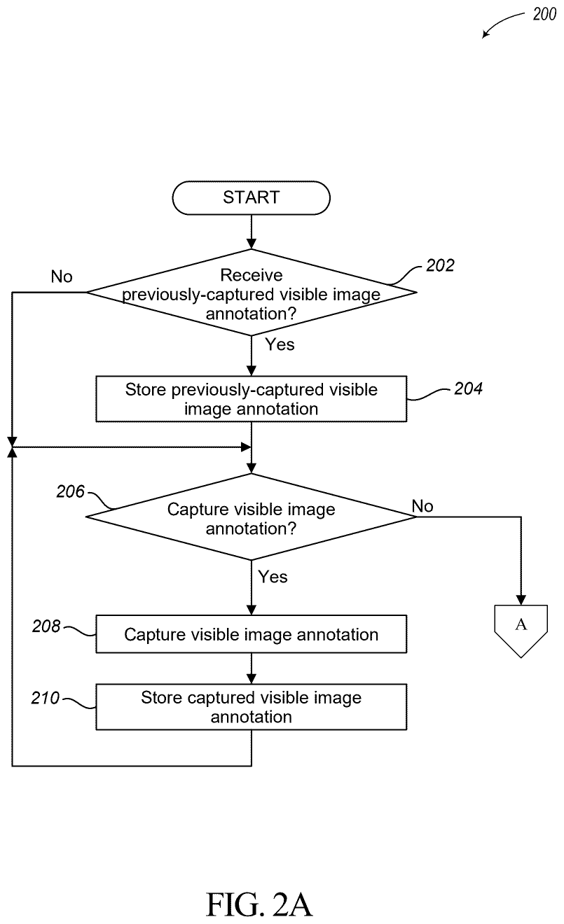

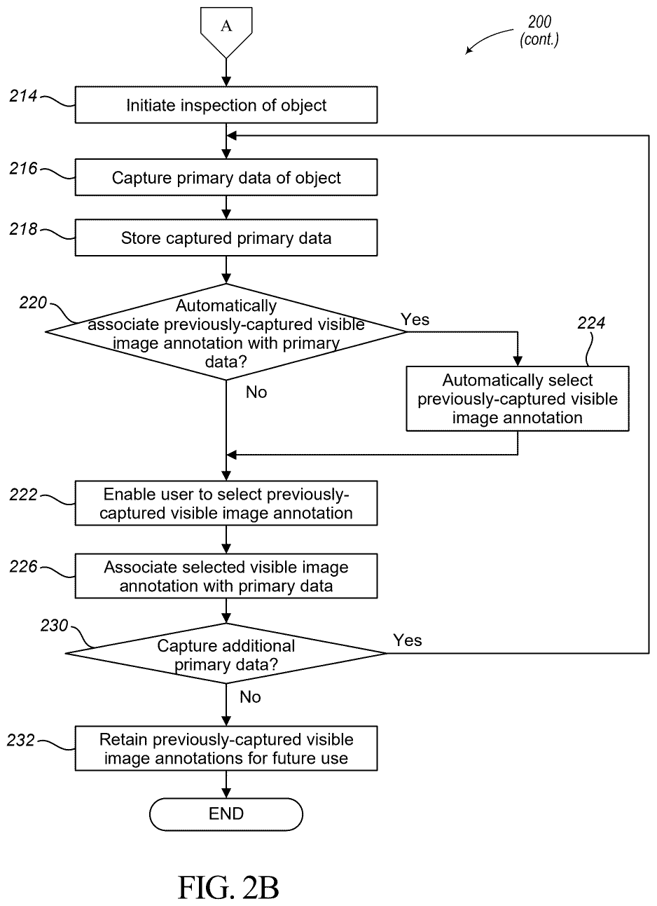

FIGS. 2A-2B illustrate a logical flow diagram showing one embodiment of a process 200 for dynamically capturing and annotating visible images relative to use of an inspection sensor in accordance with embodiments described herein. In at least one of various embodiments, process 200 may be implemented by or executed via circuitry on inspection device 102 in FIG. 1. Although process 200 is described with respect to utilization of previously-captured visible image annotations, other types of previously-captured annotations (e.g., sound records) may also be utilized in some embodiments.

Process 200 begins, after a start block in FIG. 2A, at decision block 202, where a determination is made whether a previously-captured visible image annotation has been received. A previously-captured visible image annotation is a visible-light image that is captured by a visible-light camera prior to an inspection being initiated at block 214 in FIG. 2B and is used to annotate inspection data. In various embodiments, one or more previously-captured visible image annotations are downloaded on or provided to the inspection device prior to use (i.e., prior to capturing inspection data), such as from a separate inspection device, or from a server device that is separate from the inspection device, or from a smart phone (or another computing device).

In some embodiments, the previously-captured visible image annotations may be received in response to user request or interaction with the inspection device. In other embodiments, the previously-captured visible image annotations may be pushed to the inspection device without interaction by the user of the inspection device. In yet other embodiments, the previously-captured visible image annotations may have been stored during a prior use of the inspection device (e.g., by previously employing process 200 and retraining visible image annotations at block 232 for future use). If a previously-captured visible image annotation has been received, process 200 flows to block 204; otherwise, process 200 flows to decision block 206.

At block 204, the previously-captured visible image annotations (as received by the inspection device) are stored on the inspection device. In some embodiments, the previously-captured visible image annotations are stored in a temporary cache or short-term memory and can be used during one or more selected inspections, such as inspections on a particular day or at a particular location or for a particular type of inspection or for a particular object (e.g., a specific piece of equipment) or for a particular type of object (e.g., a type of machine or equipment). In other embodiments, the previously-captured visible image annotations are stored in a permanent cache or long-term memory and can be used during one or more inspections until removed or deleted from the inspection device.

Process 200 proceeds, after block 204 or from decision block 202, to decision block 206, where a determination is made whether one or more visible image annotations are to be captured. In some embodiments, a user may activate a button or select a setting on the inspection device indicating that a visible image annotation is to be captured. If a visible image annotation is to be captured, process 200 flows to block 208; otherwise, process 200 flows to block 214 in FIG. 2B.

At block 208 in FIG. 2A, a visible image annotation is captured. In various embodiments, a visible-light camera contained within or part of or in communication with the inspection device is employed to capture a visible-light image or visible-light video, also referred to as a visible image or visible video. The captured visible images or video may be of an object that is to be inspected (but not yet inspected), a location relative to the object to be inspected (e.g., a visible image of building in which the object is located), information associated with the object to be inspected (e.g., a visible image of levels on an electrical distribution panel), or other information related to the inspection that is to be conducted (but not yet performed). In some embodiments, the user may be enabled to utilize a graphical user interface to modify or add text o the captured visible images.

Process 200 continues, after block 208, at block 210, where the captured visible image annotation is stored on the inspection device 102. In various embodiments, the newly-captured visible image annotation is stored in short-term or long-term memory, similar to block 204. In at least one embodiment, the user may be prompted via a graphical user interface to select how the newly-captured visible image annotation is stored. Once stored, this newly-captured visible image annotation becomes a previously-captured image annotation because it is being captured prior to inspection data being captured.

After block 210, process 200 loops to decision block 206 to determine if another visible image annotation is to be captured, such as if the user manually selects a button to capture multiple visible image annotations. If another visible image annotation is to be captured, process 200 continues block 208 to capture and store another visible image annotation; otherwise, process 200 flows to block 214 in FIG. 2B.

At block 214 in FIG. 2B, an inspection of an object is initiated. After one or more previously-captured visible image annotations are stored on the inspection device, the user of the inspection device can initiate the inspection of an object. In some embodiments, the user may initiate or activate a button or switch on the inspection device to initiate the inspection. The inspection may include positioning one or more inspections sensors on the inspection device relative to the object. For example, thermal sensors on the inspection device can be pointed towards the object such that thermal properties of the object can be detected by the thermal sensors. In other embodiments, one or more connection leads can be connected from the inspection device to the object. For example, two a connection leads can be connected to a specific circuit breaker to detect the resistance of the circuit breaker.

Process 200 continues, after block 214, at block 216, where primary data of the object is captured. This primary data is the inspection data that is captured by one or more inspection sensors on the inspection device during the inspection of the object. Examples of primary data may include electrical voltage readings, electrical current readings, electrical resistance readings, electrical power readings, vibration readings, motion recordings, thermal images, sound recordings, ultrasonic images or recordings, etc.

Process 200 proceeds, after block 216, to block 218, where the captured primary data of the object is stored on the inspection device. In various embodiments, the primary data may be stored on the inspection device as a primary data file. The primary data file may include a single piece of primary data or a plurality of primary data that is captured over time. Moreover, the primary data file may include primary data for a single object being inspection (e.g., a specific piece of equipment) or a plurality of objects being inspected (e.g., multiple circuit breakers within an electrical panel).

Process 200 continues, after block 218, at decision block 220, where a determination is made whether a previously-captured visible image annotation (i.e., stored at block 204 or block 210) is to be automatically associated with the captured primary data. In some embodiments, the user may have previously selected or determined (e.g., prior to the initiation of the inspection at block 214) that one or more of the previously-captured visible image annotations is to be automatically associated with the primary data. In other embodiments, a default setting may identify one or more of the previously-captured visible image annotations to be automatically associated with the primary data, such as based on the type of inspection, the type of previously-captured visible image annotations, etc. For example, the user may select, or a default setting may indicate, that each previously-captured visible image annotation on the same day as an inspection is to be automatically associated with the primary data. If a previously-captured visible image annotation is to be automatically associated with the captured primary data, then process 200 flows to block 224; otherwise process 200 flows to block 222.

At block 224, one or more previously-captured visible image annotations are automatically selected for association with the primary data. In some embodiments, the user may have previously selected the previously-captured visible image annotations. In other embodiments, a default setting may identify the one or more previously-captured visible image annotations that are to be selected for automatic association.

After block 224, process 200 flows to block 222.

At block 222, the user of the inspection device is enabled to select one or more previously-captured visible image annotations that are to be associated with the captured primary data. In various embodiments, the user may be presented with a graphical user interface that enables the user to navigate previously-captured visible image annotations and select one or more of the previously-captured visible image annotations. In some embodiments, such a graphical user interface may be automatically provided or displayed upon capturing the primary data. In other embodiments, the graphical user interface may be provided or displayed in response to the user activating a corresponding button or interface. In some embodiments, the user selects one or more previously-captured visible image annotations via the graphical user interface by clicking on a name, image, or other icon that corresponds to the previously-captured visible image annotations. The user can individually select one or more previously-captured visible image annotations or a plurality of previously-captured visible image annotations.

In some embodiments, the previously-captured visible image annotations may be stored in a hierarchical fashion such that if the user selects a previously-captured visible image annotation at a particular hierarchical level, then each correspondingly-connected previously-captured visible image annotation in higher levels (or levels from which the selected level depends or descends from) is automatically selected. As an illustrative example, a picture of a building in which an object is to be inspected may be stored at a first, or highest, level. A plurality of pictures of room numbers within that building may be stored at a second level. A picture of labels on a circuit breaker panel for each room may be stored at a third level. And individual pictures of each circuit breaker within the corresponding panel may be stored at a fourth, or lowest, level. In this example, if the user selects a picture of a specific circuit breaker from a specific panel in a specific room at the fourth level, then the picture of the specific circuit breaker, the picture of the labels for that specific panel, the picture of the room number in which that panel is located, and the picture of the building may be automatically selected, even though the user only selected a single previously-captured visible image annotation.

In other embodiments, the user may be enabled to modify one or more of the previously-captured visible image annotations with labels, text, or other information about the previously-captured visible image annotation or about the primary data that is to be associated with the previously-captured visible image annotation.

Process 200 proceeds, after block 222, to block 226, where the one or more user selected or automatically selected visible image annotations are associated with the primary data. In various embodiments, the selected visible image annotation is associated with the primary data by linking the selected visible image annotation to the primary data. In some embodiments, the primary data (or the primary data file containing the primary data) is tagged with metadata or other information that identifies the selected visible image annotation as being associated with the primary data. In other embodiments, the primary data itself is modified to append the selected visible image annotation to the primary data. In yet other embodiments, the selected visible image annotation may be added to the primary data file (e.g., the primary data file may include a thermal image of the primary data and a visible image from the selected visible image annotation).

Process 200 proceeds, after block 226, to decision block 230, where a determination is made whether additional primary data is to be captured. In some embodiments, the user may select or activate a button or interface to indicate that additional primary data is to be captured. If additional primary data is to be captured, process 200 loops to block 216; otherwise, process 200 flows to block 232.

At block 232, one or more of the previously-captured visible image annotations are retained for future use. In some embodiments, a previously-captured visible image annotation is stored in short-term memory and can be selected during additional inspections on a particular day or at a particular location or for a particular type of inspection. In other embodiments, a previously-captured visible image annotation is stored in long-term memory and can be used during one or more inspections until removed or deleted from the inspection device. In this way, a library of previously-captured visible image annotations can be stored and associated with other inspections. In yet other embodiments, a previously-captured visible image annotation is transmitted to another inspection device or to a server device for use in the future.

After block 232, process 200 terminates or otherwise returns to a calling process to perform other actions.

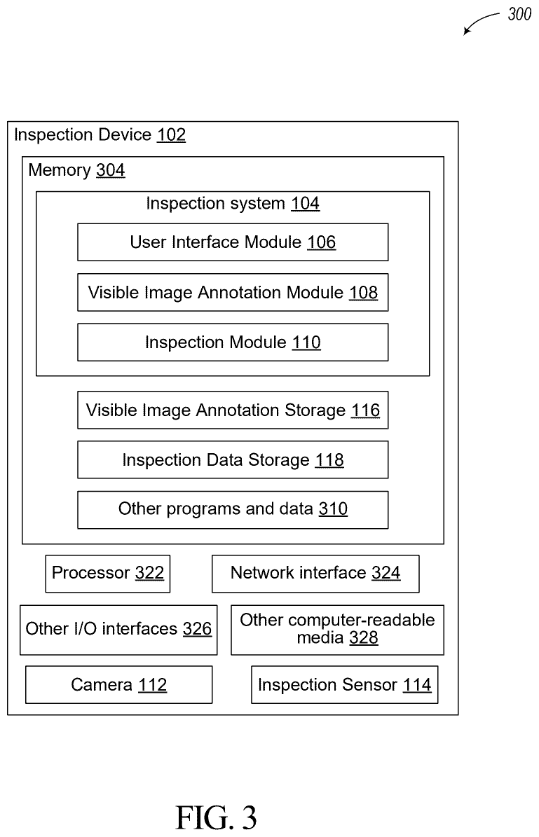

FIG. 3 shows a system diagram that describes various implementations of computing systems for implementing embodiments described herein. As described herein, inspection device 102 is configured to receive or capture visible image annotations prior to initiation of an inspection. These previously-captured visible image annotations can then be associated, automatically or as selected by a user, to primary inspection data as or after that data is captured by the inspection device 102. One or more special-purpose computing systems may be used to implement inspection device 102. Accordingly, various embodiments described herein may be implemented in software, hardware, firmware, or in some combination thereof. Inspection device 102 may include camera 112 and inspection sensor 114, as described in FIG. 1. Inspection device 102 also includes memory 304, processor 322, I/O interfaces 326, other computer-readable media 328, and network interface 324.

Memory 304 may include one or more various types of non-volatile and/or volatile storage technologies. Examples of memory 304 may include, but are not limited to, flash memory, hard disk drives, optical drives, solid-state drives, various types of random access memory (RAM), various types of read-only memory (ROM), other computer-readable storage media (also referred to as processor-readable storage media), or the like, or any combination thereof. Memory 304 may have stored thereon inspection system 104, visible image annotation storage 116, and inspection data storage 118, which are described in more detail above in FIG. 1. As described herein, the inspection system 104 may include a user interface module 106, a visible image annotation module 108, and an inspection module 110 to collectively perform embodiments described herein. The memory 304 may also store other programs and data 310 (e.g., operating systems, user profiles, inspection instructions or databases, etc.). Overall, memory 304 may be utilized to store information, including computer-readable instructions that are utilized by processor 322 to perform actions, including embodiments described herein.

Processor 322 includes one or more processors, one or more processing units, programmable logic, circuitry, or one or more other computing components that are configured to perform embodiments described herein or to execute computer instructions to perform embodiments described herein. In some embodiments, a processor system of the inspection device 102 may include a single processor 322 that operates individually to perform actions. In other embodiments, a processor system of the inspection device 102 may include a plurality of processors 322 that operate to collectively perform actions, such that one or more processors 322 may operate to perform some, but not all, of such actions. Reference herein to “a processor system” of the inspection device 102 refers to one or more processors 322 that individually or collectively perform actions. And reference herein to “the processor system” of the inspection device 102 refers to 1) a subset or all of the one or more processors 322 comprised by “a processor system” of the inspection device and 2) any combination of the one or more processors 322 comprised by “a processor system” of the inspection device 102 and one or more other processors 322.

Network interface 324 is configured to communicate with other computing devices or systems. For example, the inspection device 102 may receive one or more previously-captured visible image annotations from a server device or another inspection device. I/O interfaces 326 may include buttons, audio interfaces, display interfaces, or the like that are configured to provide or display information or data to a user or to receive input from the user. Other computer-readable media 328 may include other types of stationary or removable computer-readable media, such as removable flash drives, external hard drives, or the like.

The following is a summarization of the claims as originally filed.

A method may be summarized as an inspection device performing a first set of actions during a first time prior to an object being inspected and performing a second set of actions during inspection of the object at a second time after the first time. During the first time prior to the object being inspected, the first set of actions comprise: capturing a visible image annotation related to the object to be inspected; and storing the visible image annotation locally on the inspection device. During inspection of the object at the second time after the first time, the second set of actions comprise: capturing primary inspection data of the object; storing the primary inspection data locally on the inspection device; associating the primary inspection data that was captured during the inspection with the visible image annotation that was captured prior to the inspection such that the primary inspection data is distinguishable from the visible image annotation; and storing the association between the primary inspection data and the visible image annotation.

The method may associate the primary inspection data that was captured during the inspection with the visible image annotation that was captured prior to the inspection, including: enabling a user of the inspection device to select the visible image annotation from a plurality of previously-captured visible image annotations; and associating the selected visible image annotation with the primary inspection data.

The method may associate the primary inspection data that was captured during the inspection with the visible image annotation that was captured prior to the inspection, including: automatically selecting the visible image annotation to be associated with the primary inspection data; and automatically associating the selected visible image annotation with the primary inspection data.

The method may store the visible image annotation locally on the inspection device, including: storing the visible image annotation in a temporary cache on the inspection device for association with primary inspection data captured during the inspection.

The method may store the visible image annotation locally on the inspection device, including: storing the visible image annotation in a permanent cache on the inspection device for association with primary inspection data captured during a future inspection.

The method may further comprise: downloading at least one previously-captured visible image annotation that was captured during a prior inspection; and wherein associating the visible image annotation with the primary inspection data, includes: associating the primary inspection data that was captured during the inspection with the at least one previously-captured visible image annotation.

The method may further comprise: during a second inspection of the object at a third time after the second time: capturing second primary inspection data of the object; and associating the second primary inspection data that was captured during the second inspection with the visible image annotation that was captured prior to the inspection.

The method may further comprise: during the first time prior to the object being inspected: capturing a second visible image annotation related to the object to be inspected; and storing the second visible image annotation locally on the inspection device; and wherein associating the visible image annotation with the primary inspection data during inspection of the object at the second time, includes: associating the primary inspection data that was captured during the inspection with the visible image annotation that was captured prior to the inspection and with the second visible image annotation that was captured prior to the inspection.

The method may capture the primary inspection data of the object including at least one of: capturing infrared data of the object for inspection; capturing acoustic data of the object for inspection; capturing electromagnetic data of the object for inspection; or capturing vibration data of the object for inspection.

The method may store the association between the primary inspection data and the visible image annotation, including: storing the primary inspection data with the visible image annotation appended to the primary inspection data in a same file.

The method store the association between the visible image annotation and the primary inspection data, including: storing a tag with the primary inspection data, wherein the tag identifies the visible image annotation.

A computing device may be summarized as comprising: a memory configured to store computer instructions, at least one visible image annotation, and primary inspection data; and a processor system. The processor system may be configured to execute the computer instructions to: during a first time prior to an object being inspected: receive a visible image annotation related to the object to be inspected; store the captured visible image annotation in the memory; and during inspection of the object at a second time after the first time: receive primary inspection data of the object; associate the visible image annotation with the primary inspection data such that the primary inspection data is distinguishable from the visible image annotation; and store the primary inspection data with the association between the visible image annotation and the primary inspection data in the memory.

The processor system of the computing device may associate the visible image annotation with the primary inspection data by being configured to further execute the computer instructions to: present a user interface to a user enabling the user to select the visible image annotation from that at least one visible image annotation stored in the memory; and associate the selected visible image annotation with the primary inspection data.

The processor system of the computing device may associate the visible image annotation with the primary inspection data by being configured to further execute the computer instructions to: automatically select the visible image annotation to be associated with the primary inspection data; and automatically associate the selected visible image annotation with the primary inspection data.

The processor system of the computing device may store the visible image annotation in the memory by being configured to further execute the computer instructions to: store the visible image annotation in a temporary cache of the memory for association with primary inspection data captured during the inspection.

The processor system of the computing device may receive the visible image annotation related to the object by being configured to further execute the computer instructions to: download the visible image annotation from a database of at least one previously-captured visible image annotation that was captured during a prior inspection.

The processor system of the computing device may receive the visible image annotation related to the object by being configured to further execute the computer instructions to: receive the visible image annotation from another computing device.

The processor system of the computing device may be configured to further execute the computer instructions to: during a second inspection of the object at a third time after the second time: receive second primary inspection data of the object; associate the visible image annotation captured during the first time with the second primary inspection data; and store the second primary inspection data with the association between the visible image annotation and the second primary inspection data in the memory.

The processor system of the computing device may receive the primary inspection data of the object by being configured to further execute the computer instructions to: receive at least one of: infrared data of the object from at least one infrared sensor; acoustic data of the object from at least one acoustic sensor; electromagnetic data of the object from at least one electromagnetic field sensor; or vibration data of the object from at least one vibration sensor.

A system may be summarized as comprising: at least one sensor configured to capture primary inspection data of an object during an inspection; a camera configured to capture a visible image annotation related to the object to be inspected; a local memory configured to store at least one visible image annotation and primary inspection data; a processor system configured to execute computer instructions; and a non-transitory computer-readable medium. The non-transitory computer-readable medium may store computer instructions that, when executed by the processor system, cause the processor system to: during a first time prior to the object being inspected: cause the camera to capture a visible image annotation related to the object to be inspected; receive the captured visible image annotation from the camera; store the captured visible image annotation in the local memory; and during inspection of the object at a second time after the first time: cause the at least one sensor to capture the primary inspection data of the object being inspected; receive the captured primary inspection data from the at least one sensor; and store the captured primary inspection data in the local memory with an association between the captured visible image annotation and the captured primary inspection data.

The various embodiments described above can be combined to provide further embodiments. These and other changes can be made to the embodiments in light of the above-detailed description. All of the U.S. patents, U.S. patent application publications, U.S. patent applications, foreign patents, foreign patent applications and non-patent publications referred to in this specification or listed in the Application Data Sheet are incorporated by reference, in their entirety. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
during a first time prior to an object being inspected:
capturing, by an inspection device, a visible image annotation related to the object to be inspected; and
storing, by the inspection device, the visible image annotation locally on the inspection device; and
during inspection of the object at a second time after the first time:
capturing, by the inspection device, primary inspection data of the object;
storing, by the inspection device, the primary inspection data locally on the inspection device;
associating, by the inspection device, the primary inspection data that was captured during the inspection with the visible image annotation that was captured prior to the inspection such that the primary inspection data is distinguishable from the visible image annotation; and
storing, by the inspection device, the association between the primary inspection data and the visible image annotation.

2. The method of claim 1, wherein associating the primary inspection data that was captured during the inspection with the visible image annotation that was captured prior to the inspection, comprises:
enabling, by the inspection device, a user of the inspection device to select the visible image annotation from a plurality of previously-captured visible image annotations; and
associating, by the inspection device, the selected visible image annotation with the primary inspection data.

3. The method of claim 1, wherein associating the primary inspection data that was captured during the inspection with the visible image annotation that was captured prior to the inspection, comprises:
automatically selecting, by the inspection device, the visible image annotation to be associated with the primary inspection data; and
automatically associating, by the inspection device, the selected visible image annotation with the primary inspection data.

4. The method of claim 1, wherein storing the visible image annotation locally on the inspection device, comprises:
storing the visible image annotation in a temporary cache on the inspection device for association with primary inspection data captured during the inspection.

5. The method of claim 1, wherein storing the visible image annotation locally on the inspection device, comprises:
storing the visible image annotation in a permanent cache on the inspection device for association with primary inspection data captured during a future inspection.

6. The method of claim 1, further comprising:
downloading, by the inspection device, at least one previously-captured visible image annotation that was captured during a prior inspection; and
wherein associating the visible image annotation with the primary inspection data, includes:
associating, by the inspection device, the primary inspection data that was captured during the inspection with the at least one previously-captured visible image annotation.

7. The method of claim 1, further comprising:
during a second inspection of the object at a third time after the second time:
capturing, by the inspection device, second primary inspection data of the object; and
associating, by the inspection device, the second primary inspection data that was captured during the second inspection with the visible image annotation that was captured prior to the inspection.

8. The method of claim 1, further comprising:
during the first time prior to the object being inspected:
capturing, by an inspection device, a second visible image annotation related to the object to be inspected; and
storing, by the inspection device, the second visible image annotation locally on the inspection device; and
wherein associating the visible image annotation with the primary inspection data during inspection of the object at the second time, includes:
associating, by the inspection device, the primary inspection data that was captured during the inspection with the visible image annotation that was captured prior to the inspection and with the second visible image annotation that was captured prior to the inspection.

9. The method of claim 1, wherein capturing the primary inspection data of the object comprises at least one of:
capturing, by the inspection device, infrared data of the object for inspection;
capturing, by the inspection device, acoustic data of the object for inspection;
capturing, by the inspection device, electromagnetic data of the object for inspection; or
capturing, by the inspection device, vibration data of the object for inspection.

10. The method of claim 1, wherein storing the association between the primary inspection data and the visible image annotation, comprises:
storing, by the inspection device, the primary inspection data with the visible image annotation appended to the primary inspection data in a same file.

11. The method of claim 1, wherein storing the association between the visible image annotation and the primary inspection data, comprises:
storing, by the inspection device, a tag with the primary inspection data, wherein the tag identifies the visible image annotation.

12. A computing device, comprising:
a memory configured to store computer instructions, at least one visible image annotation, and primary inspection data; and
a processor system configured to execute the computer instructions to:
during a first time prior to an object being inspected:
receive a visible image annotation related to the object to be inspected;
store the captured visible image annotation in the memory; and
during inspection of the object at a second time after the first time:
receive primary inspection data of the object;
associate the visible image annotation with the primary inspection data such that the primary inspection data is distinguishable from the visible image annotation; and
store the primary inspection data with the association between the visible image annotation and the primary inspection data in the memory.

13. The computing device of claim 12, wherein the processor system associates the visible image annotation with the primary inspection data by being configured to further execute the computer instructions to:
present a user interface to a user enabling the user to select the visible image annotation from that at least one visible image annotation stored in the memory; and
associate the selected visible image annotation with the primary inspection data.

14. The computing device of claim 12, wherein the processor system associates the visible image annotation with the primary inspection data by being configured to further execute the computer instructions to:
automatically select the visible image annotation to be associated with the primary inspection data; and
automatically associate the selected visible image annotation with the primary inspection data.

15. The computing device of claim 12, wherein the processor system stores the visible image annotation in the memory by being configured to further execute the computer instructions to:
store the visible image annotation in a temporary cache of the memory for association with primary inspection data captured during the inspection.

16. The computing device of claim 12, wherein the processor system receives the visible image annotation related to the object by being configured to further execute the computer instructions to:
download the visible image annotation from a database of at least one previously-captured visible image annotation that was captured during a prior inspection.

17. The computing device of claim 12, wherein the processor system receives the visible image annotation related to the object by being configured to further execute the computer instructions to:
receive the visible image annotation from another computing device.

18. The computing device of claim 12, wherein the processor system is configured to further execute the computer instructions to:
during a second inspection of the object at a third time after the second time:
receive second primary inspection data of the object;
associate the visible image annotation captured during the first time with the second primary inspection data; and
store the second primary inspection data with the association between the visible image annotation and the second primary inspection data in the memory.

19. The computing device of claim 12, wherein the processor system receives the primary inspection data of the object by being configured to further execute the computer instructions to:
receive at least one of:
infrared data of the object from at least one infrared sensor;
acoustic data of the object from at least one acoustic sensor;
electromagnetic data of the object from at least one electromagnetic field sensor; or
vibration data of the object from at least one vibration sensor.

20. A system, comprising:
at least one sensor configured to capture primary inspection data of an object during an inspection;
a camera configured to capture a visible image annotation related to the object to be inspected;
a local memory configured to store at least one visible image annotation and primary inspection data;
a processor system configured to execute computer instructions; and
a non-transitory computer-readable medium storing computer instructions that, when executed by the processor system, cause the processor system to:
during a first time prior to the object being inspected:
cause the camera to capture a visible image annotation related to the object to be inspected;
receive the captured visible image annotation from the camera;
store the captured visible image annotation in the local memory; and
during inspection of the object at a second time after the first time:
cause the at least one sensor to capture the primary inspection data of the object being inspected;
receive the captured primary inspection data from the at least one sensor; and
store the captured primary inspection data in the local memory with an association between the captured visible image annotation and the captured primary inspection data.
